(19) United States
(12) Patent Application Publication
(10) Pub. No.: US 2026/0270245 A1
(43) Pub. Date: Sep. 10, 2026

(54) SYSTEMS AND METHODS FOR CONTENT DISTRIBUTION OVER NETWORKED SITES

(71) Applicant: ProrataAI, Inc., Pasadena, CA (US)

(72) Inventor: William Tod Gross, Pasadena, CA (US)

(21) Appl. No.: 19/557,610

(22) Filed: Mar. 5, 2026

Related U.S. Application Data
(60) Provisional application No. 63/768,742, filed on Mar. 7, 2025.

(51) Int. Cl. H04L 9/40

(52) U.S. Cl. CPC H04L 63/0428; H04L 63/166

(57) ABSTRACT

Systems and methods are described for routing digital content in networked computing environments using machine-learning techniques. A computer system receives an encrypted prompt over a network via a network interface and decrypts the prompt for processing. Using a computer-executed model, the system infers a desired state from free-form natural language text and generates a representation of the prompt. Based at least on the desired state, the system identifies a first networked site suitable for delivering a first item of content. The first item of content is transmitted over a network and rendered on a display of a user device via the identified networked site. The disclosed techniques enable efficient selection of networked sites for content routing while reducing unnecessary network and processing overhead in distributed systems.

### BACKGROUND OF THE INVENTION

### Incorporation by Reference to any Priority Applications

Any and all applications for which a foreign or domestic priority claim is identified in the Application Data Sheet as filed with the present application are hereby incorporated by reference under 37 CFR 1.57.

### COPYRIGHT NOTICE

A portion of the disclosure of this patent document contains material which is subject to copyright protection. The copyright owner has no objection to the facsimile reproduction by anyone of the patent document and/or the patent disclosure as it appears in the United States Patent and Trademark Office patent file and/or records, but otherwise reserves all copyrights whatsoever.

### BACKGROUND

### Field of the Invention

The present disclosure relates to digital content distribution and enhancing the performance thereof.

### Description of the Related Art

The networked distribution of digital content has become one of the primary methods of distributing content. However, given the vast number of different characteristics of content consumers, it has become increasingly challenging to efficiently and effectively distribute content so as to satisfy the technical goals of the content creators as well as the interests of the content consumers.

Thus, content is often delivered to users that are not interested in consuming the content and that are not the desired consumers of the content creators. This results in a tremendous waste of computer resources, network resources, and energy used in such inefficient distribution of content.

Thus, what is needed are comprehensive techniques for determining desired consumers of content and optimized techniques for routing content over networks to such desired consumers of content.

### BRIEF DESCRIPTION OF THE DRAWINGS

While each of the drawing figures illustrates a particular aspect for purposes of illustrating a clear example, other embodiments may omit, add to, reorder, and/or modify any of the elements shown in the drawing figures. For purposes of illustrating clear examples, one or more figures may be described with reference to one or more other figures, but using the particular arrangement illustrated in the one or more other figures is not required in other embodiments.

FIG. 1 illustrates an example networked environment.

FIG. 2 illustrates and example device architecture.

FIG. 3A illustrates an example neural network architecture.

FIG. 3B illustrates an example transformer architecture.

FIG. 4 illustrates an example prompt user interface.

FIG. 5 illustrates an example content distribution process.

### DETAILED DESCRIPTION

As similarly discussed elsewhere herein, the networked distribution of digital content to user devices has become one of the primary methods of distributing content. However, it has become increasingly challenging to efficiently and effectively distribute content so as to satisfy the technical goals of the content creator as well as the interests of the content consumers.

Thus, content is often delivered to users that are not interested in consuming the content and that are not the desired consumers of the content creators. This results in a tremendous waste of computer resources, network resources, and energy used in such inefficient distribution of content. Methods and systems are described herein that result in more efficient distribution of content, resulting in a reduction in the network bandwidth, computer processing utilization, memory utilization, and energy needed to distribute digital content so that such content reaches the devices of the desired content consumers.

As will be described herein, an aspect of the present disclosure relates to generating a content distribution campaign using a natural language, free form, text prompt from an entity (e.g., a provider (or representative or agent thereof) of a product or service that will be the subject of the content being distributed via the content distribution campaign). As described herein, the prompt may be provided to an artificial intelligence (AI) generative model, that output of which may be used to generate the content distribution campaign. A generative model/agent may be utilized to provide planning, curation, creative optimization, brand safety, and to place and refine contextually relevant content (e.g., advertisements) in real-time. Thus, the disclosed systems and methods provide AI agents configured to perform contextual analysis for content placements, instantly, and at scale.

For example, the prompt may be utilized to select content (e.g., advertisements comprising text, still images, video, audio, graphics, and/or the like) to achieve a goal (sometimes referred to herein as a desired state, or success criterion) expressed in the prompt, and identify content sites that are in consonance with the goal. A determination may be made as to where on the content sites the entity content is to be placed. The performance of the placed entity content may be monitored and tracked on one or more of the sites and their performance may be tracked. The performance may comprise how many times a given entity content site placement results in achievement of the goal expressed in the prompt. Using the tracked performance, the generative model may be improved to achieve more successful goal achievement.

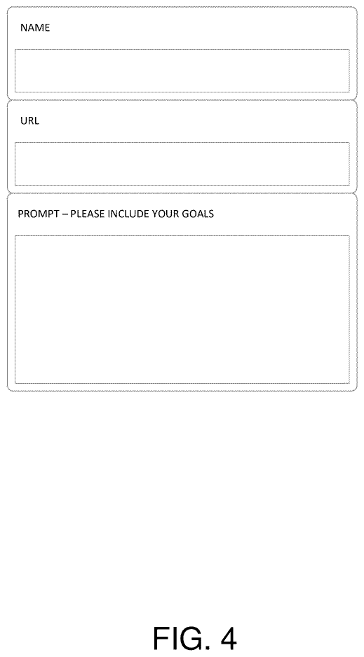

By way of example, a user interface, such as the example illustrated in FIG. 4, comprising one or more fields may be generated. For example, the fields may include an entity name field configured to receive the name of the entity, a locator field configured to receive a URL or other locator to an electronic destination/landing page (e.g., of a home page of an entity website or of a product/service page that is to be the subject of an ad campaign), and a prompt field configured to receive a free form natural language entity prompt. The user interface may be transmitted to a device of an entity that wishes to distribute their content to users so as to satisfy one or more goals specified by the entity.

Conventionally, such entities specify certain detailed desired content consumer characteristics, such as numerous demographic characteristics (e.g., age, gender, marital status, income, level of education, geographic location, etc.), desired audiences, regions, and/or keywords, which are very specific and technical. However, given the large number of content consumer characteristics, audiences, regions, and keywords, the process of specifying such criteria is highly complex, time consuming, and requires a great deal of expertise and research. Further, even if such criteria are specified, they may not result in entity content being placed at the most productive networked sites and hence may not result in the adequate achievement of the desired goals of the entity.

By enabling the entities to specify goals in free form, natural language text (and optionally budgeting data, such as how much the entity is will to pay for placement of the entity content (e.g., cost per click (CPC), cost per mille (CPM) impressions, cost per action (CPA), and/or the like) and a total budget for a content distribution campaign) rather than merely specifying quantitative criteria, a generative model-content distribution system, such as described herein, may determine optimized techniques and campaigns for distributing content, via selected networked sites, to thereby better reach viewers that are more likely to result in the satisfaction of corresponding entity goals. Further, by having an AI generate a content distribution campaign based on, partially or solely, a free form text prompt, a much larger pool of users may initiate such a campaign, even if they have little training or experience in content distribution campaigns.

Once the entity prompt and other form data are received via the user interface, the prompt may be input to a learning engine, such as a generative artificial intelligence (AI) model, examples of which are described herein. The generative AI model may identify appropriate networked sites (e.g., website) and/or content on which to place the content. Optionally, when a locator (e.g., a URL) associated with an entity website or webpage is submitted in association with the prompt, the corresponding website (or specific webpage) may have its content scraped and indexed. Such scraped content may be utilized in conjunction with the entity prompt to select and/or generate entity content (e.g., text, graphics, still images, video images, audio, etc.) to distribute, may be utilized to associate a landing page link with the distributed entity content, and may be utilized in determining on which webpages/website such entity content is to be placed. The AI model may be configured as an agentic AI model that acts as an autonomous agent capable of making decisions, setting goals, and taking actions, such as those described herein (e.g., determining goals from prompts, generating content, determining where to place content, monitoring goal success, improving content placement, etc.) to achieve objectives with little or no human intervention. The agentic AI model may proactively plan, adapt, and/or interact rather than just passively respond to inputs.

For example, a system may process the entity's free-form, natural language text input received via the form, which may describe background information and specific goals. Thus, instead of relying on static keywords, entities/marketers may enter via the prompt interface or upload their creative brief for a content distribution campaign, which may include some or all of the following: objectives, target audiences, core messaging, style and tone, brand background information, brand safety considerations, and/or the like. One or more AI agents may be utilized to generate, select, and/or place entity content on various platforms, such as websites and social media platforms, optionally without employing user-specified keywords.

Optionally, the entity may provide one or more links, locators, and/or other background information via a website or other network-accessible resource (e.g., one or more websites associated with the entity, third-party websites, social media pages, product pages, brand guideline repositories, or other electronic destinations). Such resources may be accessed, crawled, scraped, indexed, and/or otherwise analyzed by a generative model or associated processing components to extract and derive contextual information relevant to a content distribution campaign. By way of example, the generative model may analyze textual, visual, audio, and/or structural content from the provided resources to infer or identify attributes such as intended or existing target audiences, demographic or psychographic characteristics, core messaging themes, value propositions, brand positioning, stylistic preferences, tone of voice, visual aesthetics, compliance constraints, brand safety considerations, and/or other characteristics. The derived information may be used alone or in combination with the free-form prompt provided by the entity to inform goal inference, content generation or selection, creative optimization, networked site selection, bid valuation, and/or ongoing performance optimization, thereby enabling the system to more accurately align distributed content with the entity's objectives while reducing reliance on manually specified keywords, rules, or campaign parameters.

For example, a goal may be having a viewer viewing the content take a specific action. By way of illustration, if the entity is an automobile company and the entity content is related to an automobile of the company, the goal may be to have a high-income viewer schedule an appointment to drive the vehicle. Thus, the AI model will identify suitable websites/webpages to place entity content so as to better achieve the goal. An example entity prompt is as follows:

“This campaign is for Acme Motors. We are looking for people who are interested in purchasing a luxury electric vehicle. An advantageous characteristic of our electric vehicle is long range, so we would like to target people who have a concern about range anxiety or who live in suburbs a good distance away from a city center. Acme Motors is a manufacturer of luxury vehicles, and so we would like to target the higher end of the car market. We are looking for consumers that are moving away from other luxury car makes, such as Mercedes or Lexus. We want to get people to do a test drive of our electric vehicle at one of our showrooms or dealerships, so we are looking for people who live or work near their locations.”

In the foregoing example, the test drive may be utilized as a metric of engagement, wherein the test drive may be identified by the AI model as such a metric. This metric identified by the AI model may be utilized to track the performance of the placement of corresponding entity content. Thus, in this example, if a viewer of the entity content takes a test drive of the vehicle, the corresponding engagement goal is determined to have been met for the corresponding impression. If a viewer of the entity content does not take a test drive of the vehicle, the corresponding engagement goal is determined to not have been met for the corresponding impression.

A generative language model, such as described herein, configured for natural language understanding and semantic matching, parses the input, extracting structured details while interpreting vague or contextual references (e.g., “campaign” by mapping it to an ad campaign, “a good distance away” by mapping it to 30 miles or more, “high income viewer” by mapping it to a table of income classifications, “near” by mapping it to “within 20 miles”). Thus, the generative model processes the free-form text to extract important attributes such as a type of item being presented (e.g., automobile, jewelry, clothing, furniture, etc.), an indication as to a relative cost of the item (e.g., luxury, expensive, economical, value oriented, etc.), location data (e.g., nationwide, a specific state, a specific region, a specific state, or specific zip code(s)), date, time range, and goal(s), etc.

The AI model may be configured to determine an entity's/user's goal from their prompt by analyzing the linguistic structure, extracting key entities, and using contextual reasoning. One optional technique utilizes intent recognition, where the model classifies the prompt into predefined categories, such as content placement, content generation, viewer responses, or problem-solving. Semantic parsing may be utilized to break down the prompt into actionable components, identifying what the user is asking for and in what context.

Additionally, embedding-based similarity matching can compare the user's prompt with a database of known goals, using techniques such as cosine similarity (described elsewhere herein) to find the closest match(es). Generative reasoning may be utilized to enable the model to generate, identify, infer, expand or rephrase the prompt to explicitly state the underlying goal, making it easier to understand ambiguous requests. Optionally, few-shot learning may be utilized to refine this process by providing examples of prompts and their inferred goals to the model, training the model to generalize across different user intents. In cases of uncertainty, a multi-turn dialogue process may be utilized that enables the model to ask the user clarifying questions to refine its understanding. By combining these methods, the generative model may accurately infer the user's intent, ensuring more relevant generation, selection and/or placement of the entity's content.

Optionally, the system may be configured to interpret an entity's prompt as expressing one or more hierarchical goals, wherein a primary goal is decomposed into a plurality of sub-goals arranged in a logical or tree-based structure. A given sub-goal may correspond to a distinct intermediate objective, success criterion, or measurable outcome that contributes to achievement of the primary goal, and different sub-goals may be executed, evaluated, and/or optimized using different criteria, signals, and/or constraints. For example, a high-level goal inferred from a prompt may involve brand awareness, user engagement, and conversion, one or more of which may be associated with respective sub-goals having different performance metrics, timing considerations, and/or audience characteristics. Optionally, the system may be configured to enhance goal interpretation using a corpus of known goals, workflows, and/or task structures associated with a particular domain or industry. Such known goals and associated sub-goals may be learned by training a small language model (SLM), large language model (LLM), and/or other generative or predictive model on domain-specific documents, training materials, articles, books, playbooks, and/or other reference content that describe how goals are conventionally defined, decomposed, executed, and measured within that domain. By learning domain-specific goal structures and evaluation methodologies, the model may more accurately infer intended goals from free-form prompts, map inferred goals to executable sub-goals, determine appropriate sequencing or prioritization of sub-goals, and/or assess progress toward goal completion using learned performance indicators, thereby improving alignment between the entity's intent and the system's content generation, placement, and optimization decisions.

The extracted information may then be encoded into a numerical vector representation (embedding) using a pretrained language model such as Bidirectional Encoder Representations from Transformers (BERT) models or the Sentence Transformers Python module. This embedding captures semantic meaning rather than just keyword matches, enabling the system to understand nuances.

The model then queries a database (e.g., comprising indexes of scraped websites) or an external API to identify networked sites (e.g., websites) that have suitable viewership that match the criteria (e.g., have high income viewership that own certain expensive model vehicles, that live more than 30 miles from a city center, and within 20 mils of an entity showroom), using embeddings or similarity scoring techniques to rank potential options based on relevance. For example, websites of a plurality of publishers (e.g., those that are members of a content placement network) may be pre-scraped or may be scraped in response to a request for content (e.g., a content impression wherein a fee is paid to the published for the placement) to be placed on a website webpage. Scraping techniques are further described in the attached Appendices A and B, the content of which are incorporated herein in their entirety.

For example, a given networked site profile may be represented in the database as an embedding. This may comprise encoding relevant structured and unstructured data, such as viewership data (e.g., age, gender, income, interests, search history), item description (e.g., luxury automobile, hi-fashion, clothing, jewelry, diamonds), location information, etc.

These details are transformed into embeddings using optionally the same model as that used to encode the entity campaign prompt, ensuring they exist in the same vector space as the entity's campaign prompt.

Once the user entity prompts and networked site profiles are embedded into the same vector space, cosine similarity or Euclidean distance may be used to measure how closely each networked site embedding matches the entity prompts. The cosine similarity score may be calculated as:

$$similarity = \frac{A \cdot B}{‖ A ‖ \times ‖ B ‖}$$

where A is the entity's prompt embedding and B is the networked site's embedding. A higher score (closer to 1) indicates a stronger match.

The system ranks networked sites from highest to lowest similarity score. Additional weighting factors may option be applied, such as:

Higher weight for location proximity if the entity specified a tight location radius.

Higher weight on income levels descriptors if the entity emphasized cost aspects (e.g., luxury, consumers who want the best, consumers who like to be pampered, viewers looking for value products, etc.).

After ranking the websites, optionally, a determination may optionally be made if the top networked site(s) (e.g., the top 1, 2, 5, 10, 20, 100 sites) content placement costs satisfy any such specifications or limits specified by the entity. If the costs are acceptable, the entity content (e.g., the ad) may be placed on the corresponding networked site(s). Optionally, the closer the match of the prompt to the site, the higher the fee that may be offered for placement of the entity content (e.g., using the bidding or other placement scenarios described herein and using techniques described in the attached Appendices A and B, the content of which are incorporated herein in their entirety).

Optionally, certain techniques may be utilized to select a landing page that a viewer of the entity's content will be navigated to in response to the viewer interacting with the entity content (e.g., by clicking on the content, which may comprise a link to the landing page).

Optionally, a question-based approach may be utilized. The landing page may be viewed as the “answer.” A determination may be made as to what would be related question(s) to trigger such an answer. A generative model may be utilized to generate and index the top specified number questions related to the landing page. The questions may be indexed. At query run time, question-to-question semantic matching may be executed.

Optionally, a claims-based design may be utilized. A generative model may be utilized to distill the landing page into canonical statements (claims). The claims may be indexed. At query run time, AI-generated responses may be installed into semantically canonical claims, and claim-to-claim semantic matching may be executed.

Optionally, once a certain number of top networked site(s) are identified, one or more of the following techniques may be utilized to attempt to place the entity content on such a site.

Optionally, native advertising may be utilized to place entity content, where ads blend seamlessly into networked site content, and social media integrations may be utilized to enable less intrusive placements.

The foregoing processes ensure that the generative model not only understands user intent but also finds optimized matches using AI-powered ranking, providing a highly efficient content placement, with a much greater likelihood of campaign goal achievement. Thus, the system may optionally operate as an ad network, automatically matching ads with relevant networked sites based on the AI-ranking and optionally bidding strategies. For example, the system may place real time bids with respect to the ranked network sites. When a user visits a networked site, an instant auction occurs where multiple entities bid (which may be referred to as a placement control value) for the available ad space, and the highest bidder's ad is displayed in milliseconds. Thus, the system may automatically submit bids in real time for one or more of the AI-ranked sites. The bids may be in the form of tokens comprising a currency.

In certain content placement systems, in order to compete in a placement auction, the content (e.g., ads) needs to reach quality and relevant thresholds (which may be referred to as rank thresholds). Content that satisfies the rank thresholds may be ranked to select the winning bid(s). The ranking may be based on one or more criteria, such as placement control value (e.g., the amount of tokens), content quality, expected click through rate, user signals and/or attributes. Advantageously, because the bidding for placement of the entity content is specifically targeted to sites or content that are relevant to the entity's goals and to achieve a desired viewer response, it is more likely that the entity content will be relatively more relevant to the site/content and its viewers and so will likely receive a higher ranking, increasing the likelihood that the placement control value will be accepted and the entity content will be placed.

Optionally, a language model may be configured (e.g., prompted and/or trained) to automatically compute incremental distance scores for contextually relevant entity content (e.g., cosine distance scores such as described elsewhere herein) between the site/content and the entity prompt/goals (e.g., values from 0 to 1 or 100%, where a value of 1 indicates high relevance of the site/content to the entity's prompt/goals and a value of 0 indicates no relevance of the site/content to the entity's prompt/goals). Accordingly, the amount that the entity is willing to pay/bid for placement of the entity content may be based in part on the size of the corresponding incremental distances. Optionally, the placement control value may be provided by the entity in the form of a CPC, CPM, or CPA (Cost Per Action, where the action may be a specified entity goal, such as the viewer taking a test drive of an automobile manufactured/sold by the entity, a visit to a restaurant showroom or store of the entity, etc.).

As discussed above, a model set (which may include a predictive model configured to predict a viewer's response to content on a given website, and a generative model configured to generative ad creatives) may be utilized in the selection of entity content, the generation of entity content, and the placement of entity content. A generative model (e.g., a large language model) is a type of machine learning model that uses vast amounts of data to learn the statistical patterns of language, such as grammar, syntax, and vocabulary. By way of example, a generative model may utilize one or more neural networks and may utilize a transformer architecture. The generative model may be trained using unsupervised learning techniques.

Optionally, the collected data may undergo preprocessing to clean and format the data to be suitable for training the generative model. For example, irrelevant information may be removed, errors may be corrected, and/or data formatted so that the model can understand the data. The training text may be broken down into smaller units which may be referred to as tokens (e.g., where a token may be a single character or a set of characters such as a word). Such tokenization may enable the generative model to analyze and generate text at a granular level.

The generative model may be trained using the preprocessed dataset. During training, with respect to text outputs, the model learns to predict the next word or token in a sequence given the context of the preceding words. The training process comprises adjusting the model's parameters to minimize the difference between its predictions and the actual data. Optionally, after the initial training, the generative model may be trained on a more

specialized dataset related to a targeted task or domain to enhance its performance with respect to such tasks or domains. For example, the generative model may analyze patterns in vast amounts of item promotion data to predict performance and viewer responses to presentations promoting items (e.g., products or services), generate ad content, and generate optimized promotional content campaign strategies as described herein and as described in in the attached appendices A and B, the content of which are incorporated herein in their entirety.

Optionally, during training, the generative model's performance may be periodically evaluated on validation datasets to ensure the generative model is learning effectively and not overfitting to the training data. The training process may be modified based on these evaluations.

Optionally, a large language or other generative model may be trained using content to generate content relevant to a product, an entity, and/or website content. The training content may include books, articles, websites, and other textual content that reflects the diversity of language and knowledge. If the generative model is a multimodal model (e.g., configured to generate still/video images, graphics, and/or audio as well as text), a diverse and large dataset of images may be collected and used for training. In the case of audio, digitized audio may be utilized to train an audio generator (e.g., a neural network TTS engine). In this example, the model may be trained using historical data related to content placement and associated viewer actions.

By way of further example, a predictive analytics model may be in the form of a generative model, a classification model, a clustering model, and/or a time series model. A classification model may be in the form of a supervised machine learning model configured to categorize data based on historical data, describing relationships within a given dataset. For example, the classification model may be utilized to classify prospects into groups for segmentation purposes. A clustering model may group data based on similar attributes. For example, a clustering model may be utilized to separate prospects into similar groups based on common features and develop campaign strategies for respective groups. By way of illustration the clustering algorithm may include k-means clustering, mean-shift clustering, density-based spatial clustering of applications with noise (DBSCAN), expectation-maximization (EM) clustering using Gaussian Mixture Models (GMM), and/or hierarchical clustering.

Optionally, the achievement of entity goals submitted via the entity prompt may be monitored to determine how successful the AI model was at predicting what website/webpage entity content placements would be in achieving such goals (e.g., the AI model accuracy). Patterns of errors may be identified, model parameters may be adjusted, and the model may be further trained or retrained with new data. Thus, the model may be trained so as to learn from its past mistakes, enhance the model's prediction accuracy, and adapt to new scenarios.

Optionally, the model training data may be improved by identifying missing values. Additional training data may be accessed to provide such missing values. Optionally, missing values may be imputed from known values using statistical measures (e.g., the mean, median, or mode). Optionally, outlier observation data may be deleted from the training data if they significantly deviate from expected patterns.

With respect to training the generative model on images (such as might be scraped from websites), the images may be labeled. The labels may be utilized to determine and select which images would provide proper model training for a given task. The labels may describe the image content, the image mood, the image style (e.g., medieval, Renaissance, impressionist, abstract, Pop, Magna, etc.) the image lighting, the image source, and/or other image related data. The images may be preprocessed (e.g., resized, cropped, normalized, and/or other transformation) so that the images are in a format suitable for training the generative model.

Optionally, the images are converted into embeddings (e.g., numerical representations) that the generative model can understand. For example, the process of converting an image to embeddings may be performed using convolutional neural networks (CNNs), for image feature extraction, where the CNN may be pre-trained and may comprise an input layer, convolutional hidden layers, pooling layers, and an output layer.

For example, the training of a generative model may involve one or more of the following actions. The training of certain other types of generative models may be similarly performed.

The generative model's parameters (e.g., weights and biases) may be initialized (e.g., randomly). Input data (e.g., text) is fed into the generative model, and the generative model makes predictions. For example, in the case of language generative models, the generative model may predict the next word in a sequence given the previous words.

A loss function may be used to quantify the difference between the generative model's predictions and the actual (target) values. In order to improve the predictive accuracy of the generative model, the goal is to minimize this loss so that the prediction more closely matches the target. The gradients of the loss with respect to the generative model's parameters (e.g., weights and biases) are computed. For example, the chain rule of calculus, which calculates derivatives, may be used to calculate the error gradient of the loss function with respect to respective weights of the network. The generative model's parameters are then updated in the opposite direction of the computed error gradients (e.g., using an optimization algorithm, such as stochastic gradient descent (SGD) or the like). The foregoing process may be repeated on batches of data until the generative model's performance improves, and the loss is minimized to a satisfactory degree (e.g., below a certain threshold).

During this training process, the weights associated with neurons are adjusted to minimize the difference between the generative model's predictions and the actual outcomes. The learning rate is a hyperparameter that determines the size of the steps taken during the parameter updates.

Thus, neurons (or parameters, including weights) are adjusted based on the gradients of the loss function with respect to those parameters, and this adjustment is performed iteratively through multiple training cycles until the model achieves satisfactory performance.

It is understood that while certain examples herein may refer to text (e.g., text prompts, the generation of text content by a generative model, etc.), the systems and methods described herein may be applied to other forms of information and content, such as video and audio, in addition to or instead of text. Thus, for example, a prompt may include audio and/or video. Video and/or audio content may be generated for placement on third party sites, and so on.

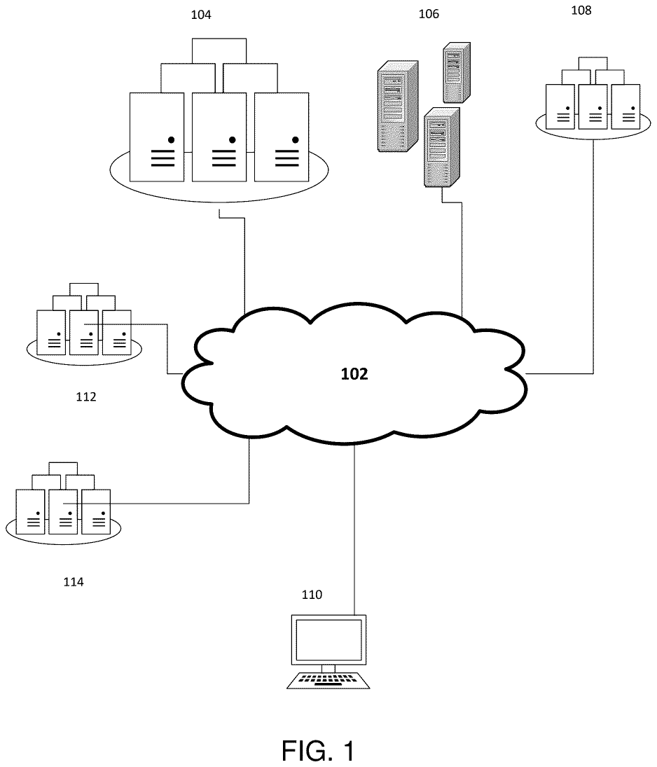

FIG. 1 illustrates an example environment which may be utilized with the processes and systems described herein. Although certain examples may refer to an LLM, the disclosed processes and systems may similarly be utilized with respect to other generative models, such as artificial intelligence (AI) image generators, Autoregressive Models, Bayesian Networks, Generative Adversarial Networks, Gaussian Mixture Models, Hidden Markov Models, Latent Dirichlet Allocation (LDA) models, and/or Variational Autoencoders (VAEs).

A content distribution system 104 is configured to generate, execute, and/or utilize a generative model. The content distribution system 104 may comprise a cloud system. With respect to the cloud-based computer system implementation, the cloud-based computer system may comprise a hosted computing environment that includes a collection of physical computing resources that may be remotely accessible, located at different facilities, and may be rapidly provisioned as needed (sometimes referred to as a “cloud” computing environment). Certain data described herein may optionally be stored using a data store that may comprise a hosted storage environment that includes a collection of physical data storage devices that may be remotely accessible and may be rapidly provisioned as needed (sometimes referred to as “cloud” storage).

The content distribution system 104 may ingest vast amounts of text content and optionally image and sound content from a large variety of sources (e.g., webserver 106, database 108, or the like) including webpages, books, magazines, articles, advertisements, and other publications. Such data may be used to train the content distribution system 104 models (e.g., using an unsupervised or supervised learning approach). The content distribution system 104 may access such content from corresponding systems over a network 102 (e.g., the Internet, an intranet, a wide area network, etc.).

Optionally, the content distribution system 104 may utilize natural language processing (NLP) to extract keywords and/or perform sentiment analysis to determine the intent/goals and other information from a prompt.

The content distribution system 104 may communicate with one or more end user/entity devices 110 (e.g., a computing device, such as a smartphone, a desktop computer, a laptop computer, a tablet, a smart television, a game console, a smart watch or other wearable, and/or the like) over the network 102. For example, the content distribution system 104 may provide one or more user interfaces (e.g., in a webpage or an application) via which a user may enter prompts or queries, URLs, identifiers, and/or other data described herein. The prompts, queries, and/or other data entered (e.g., via a keyboard, voice, or otherwise) by the user into corresponding user interface fields may be transmitted from the user device 110 to the content distribution system 104. The content distribution system 104 may in turn generate a content distribution campaign, such as described elsewhere herein.

The communication between two or more of the systems described herein may be encrypted to enhance the security, integrity, and privacy of data exchanged between systems (e.g., advertiser systems, ad exchanges, and publishers during real-time bidding (RTB) transactions). Transport Layer Security (TLS) encryption may optionally be used to place entity content, secure placement control value requests and responses over HTTPS, preventing data interception and tampering. Public Key Infrastructure (PKI) and asymmetric encryption, such as RSA, may optionally be utilized to securely exchange cryptographic keys between systems, ensuring that data, such as sensitive bidding information and user data, remains confidential. To enhance privacy, homomorphic encryption may optionally be utilized to enable placement control value data to be processed while still encrypted, enabling entities promoting products or services to analyze trends without exposing user data. Optionally, hashing algorithms (e.g., SHA-256 or HMAC) may be utilized to anonymize user identifiers, protecting personal data while enabling audience segmentation and targeting. Optionally, Elliptic Curve Cryptography (ECC) may be utilized, which advantageously provides strong encryption with lower processing overhead. Utilizing one or more of the foregoing encryption techniques, the various systems and platforms may remain secure, user data privacy may be maintained, and content placement performance may be enhanced.

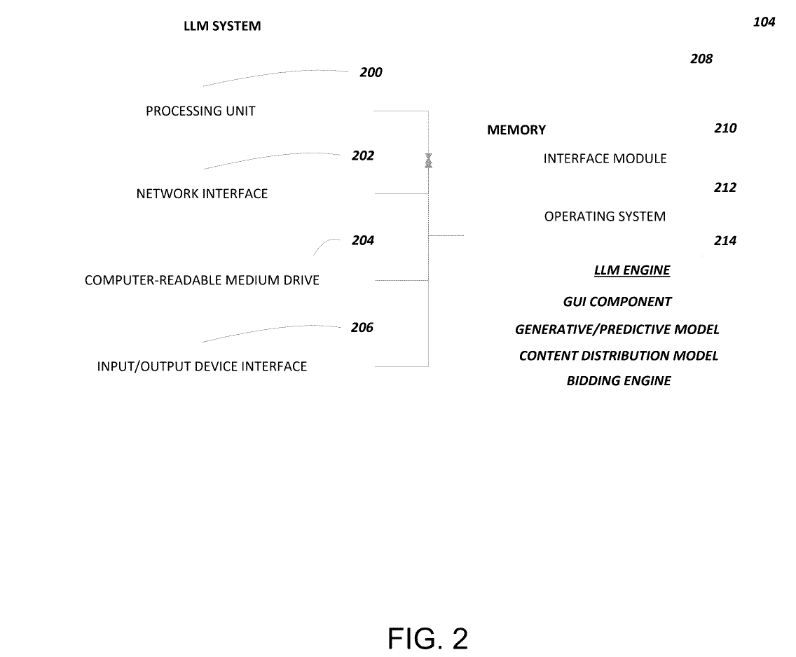

FIG. 2 is a block diagram illustrating example components of the content distribution system 104. The example content distribution system 104 includes an arrangement of computer hardware and software components that may be used to implement aspects of the present disclosure. Those skilled in the art will appreciate that the example components may include more (or fewer) components than those depicted in FIG. 2. Optionally, computer hardware and/or software components illustrated in FIG. 2 may be instead or also be included in other systems depicted in FIG. 1.

The content distribution system 104 may include one or more processing units 200 (e.g., one or more general purpose processors and/or high speed graphics processors comprising one or more processor cores including arithmetic logic units, FFT processors, registers, input/output buses, and/or the like), one or more network interfaces 202, a non-transitory computer-readable medium drive 204, and an input/output device interface 206, all of which may communicate with one another by way of one or more communication buses. The processing cores may be arranged in one or more arrays and may be interconnected via a high-speed bus. The processing cores may be configured to execute convolution instructions to enhance the performance of AI model execution. The network interface 202 may provide services described herein with connectivity to one or more networks or computing systems (e.g., generative model systems, webservers, user devices, etc.). The processing unit 200 may thus receive models and/or information (e.g., generative model models, webpages, other content used to train the generative model models, authorization to use content for model training, etc.), and/or instructions from other computing devices, systems, or services via a network, and may provide responsive data and/or execute instructions. The processing unit 200 may also communicate data to and from memory 204 and further provide output information via the input/output device interface 206. The input/output device interface 206 may also accept input from one or more input devices, such as a keyboard, mouse, digital pen, touch screen, microphone, camera, etc.

The system 104 may be configured to interact with one or more ad networks 112 and/or publisher servers 114 to place bids for entity content placement and/or to distribute entity content for placement on publisher websites/webpages.

The memory 208 may contain computer program instructions that the processing unit 200 may execute to implement one or more aspects of the present disclosure. The memory 208 may include RAM, ROM (and variants thereof, such as EEPROM) and/or other persistent or non-transitory tangible computer-readable storage media. An interface module 210 may provide access to data in the memory 208 and may enable data to be stored in the memory 208. The memory 208 may store an operating system 212 that provides computer program instructions for use by the processing unit 200 in the general administration and operation of a generative model engine 214, including its components.

The memory 208 may store user data (for end users and/or training content submitters), such as user credentials, user preferences with respect to the generation of generative model responses, a history of prompt, prompt responses, and/or other content and data described herein.

Some or all of the data and content discussed herein may optionally be stored in a relational database, an SQL database, a NOSQL database, or other database type. Optionally, the memory 208 may include one or more external third-party cloud-based storage systems.

The generative model engine 214 may include a GUI component that generates graphical user interfaces and processes user inputs (e.g., generative model queries/prompts, content submissions, agreements that submitted content (e.g., text, image, and/or audio) may be used for training, and/or other user inputs described herein) and an generative model (e.g., a generative and/or predictive model comprising a neural network, such as an encoder-decoder recurrent neural network, optionally comprising a transfer architecture) configured to generate and/or select content (e.g., text, still images, video images, audio, etc.) to present to viewers. The generative model may be trained using some or all of the data described herein and/or other data.

Optionally, the generative model engine 214 may comprise a transformer architecture that utilizes self-attention, which enables the model to selectively focus on different parts of the input sequence during the encoding process. The transformer architecture may comprise an encoder and a decoder, connected through one or more multi-head attention and feedforward layers.

The encoder is configured to receive an input sequence and process it using multi-head self-attention, where the input sequence is transformed into a set of query, key, and value vectors. The query, key, and value vectors may be used to compute the attention scores between given positions in the sequence, enabling the model to identify the relevant (e.g., most relevant) portions of the input sequence for respective positions.

The decoder is configured to receive the encoder output and generate an output sequence. The decoder may also utilize multi-head attention and may be further configured with an additional attention mechanism that enables the decoder to attend to the encoder output and to generate the output sequence using the relevant information from the input sequence. For example, an attention module may repeat its computations several times in parallel, which may be referred to as respective attention heads. Optionally, the attention module splits Query, Key, and Value parameters N-ways and passes each, independently, through a separate attention head.

The transformer architecture may comprise one or more feedforward layers, which apply a linear transformation followed by a non-linear activation function to the output of the attention layers. The feedforward layers facilitate further capture patterns in the input and output sequences.

The transformer may comprise a loss function that measures the difference between the predicted output sequence and the true output sequence. The transformer is configured to minimize or reduce the loss function output. Backpropagation may be utilized as part of the minimization process, where the gradients of the loss function with respect to the model parameters are calculated and used to update the model weights (e.g., associated with neural network layers).

A content distribution model is used to determine optimized placement of entity content on third-party websites/webpages as discussed elsewhere herein. A bidding engine is optionally provided to submit a placement control value to place entity content on such third-party websites/webpages as discussed elsewhere herein.

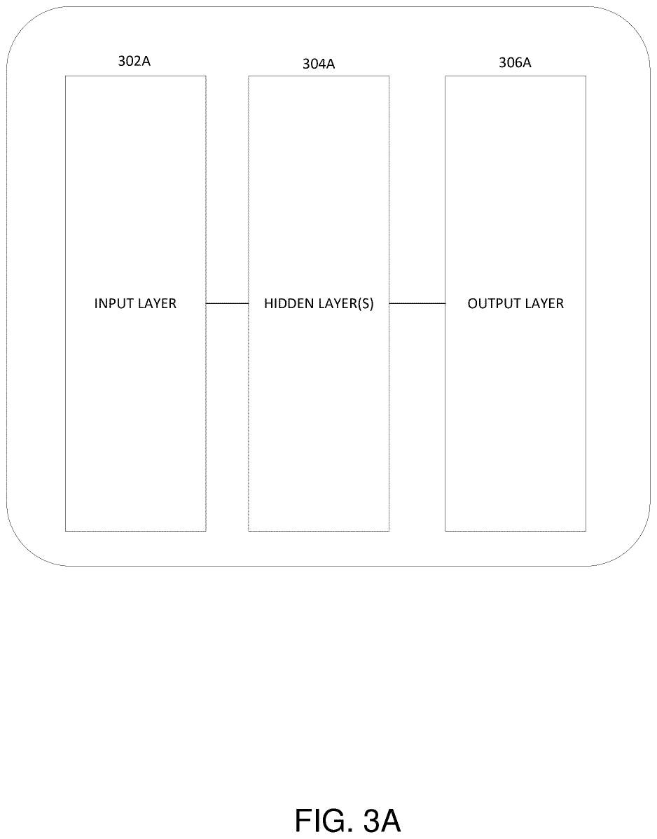

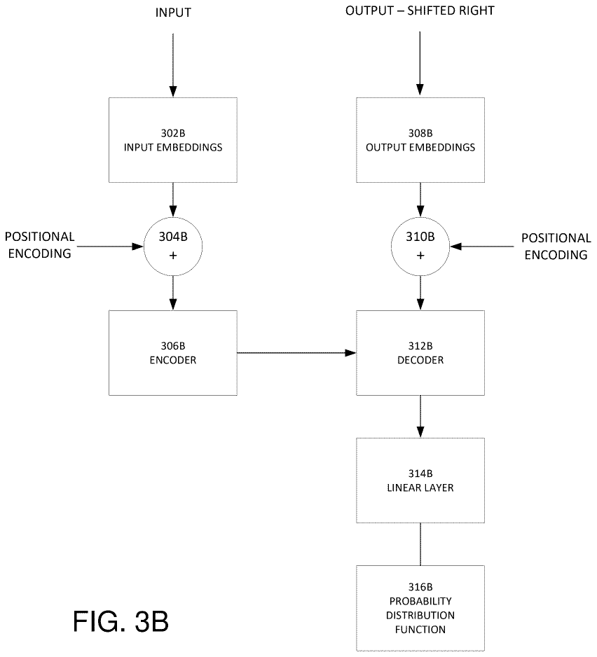

An example of a neural network configured to generate responses to user queries/prompts, such as that described herein, is illustrated in FIG. 3A.

The neural network may contain an input layer 302A, one or more hidden layers 304A, and an output layer 306A. The hidden layers 304A may be configured as convolutional layers, pooling layers, fully connected layers and/or normalization layers. For example, the neural network may be configured with one or more pooling layers that combine outputs of neuron clusters at one layer into a single neuron in the next layer. Max pooling and/or average pooling may be utilized. Max pooling may utilize the maximum value from each of a cluster of neurons at the prior layer. Average pooling may utilize the average value from each of a cluster of neurons at the prior layer.

The training data (e.g., text, image, or audio) may comprise data scraped from one or more websites, from one or more databases, or may be obtained from other sources.

The neural network may be trained using a supervised or unsupervised process. The neural network layer node weights may be adjusted using backpropagation based on an error function output with respect to the accuracy/relevance of the content generated and/or selected by the neural network, to thereby lower the error. The changes of weights may be recorded in memory as the neural network is being trained by respective items of training content. Such recorded changes in weights may be used to generate feedback as similarly discussed elsewhere herein.

A transformer model may be utilized to generate and/or select content for a user as part of a generative model (e.g., an LLM or other generative model). In addition, a transformer model may be utilized to analyze the output of another generative model, such as an LLM. Referring now to FIG. 3B, an example transformer model architecture is illustrated.

Block 302B is configured to receive tokens (a sequence of characters or subwords that represent a single unit of meaning within the input text) and generate input embeddings, where the input text is converted into a numerical format, sometimes referred to as input embeddings. The input embeddings represent words as numbers so as to be suitable for machine learning model processing. During training, the model learns how to create such embeddings so that similar vectors represent words with similar meanings.

Positional encoding may be utilized to encode the position of a given word in the input sequence as a set of numbers. The set of numbers may be input to transformer model 304B, in association with the input embeddings, to enable the model to understand the order of words in a sentence and generate grammatically correct and semantically meaningful output.

A neural network encoder 306B processes the received text and generates a series of hidden states that encapsulate the text context and the text meaning and that represent the input text at different levels of abstraction. Optionally, there may be a plurality of encoder layers. Optionally, the encoder tokenizes the input text into a sequence of tokens (e.g., words or sub-words), and applies one or more serial attention layers, such as individual words or sub-words. Advantageously, such attention layers enable the transformed model to selectively focus on different parts of the input sequence rather than having to treat each word or sub-word the same way, and further advantageously, enables relationships between inputs significantly distanced apart in the sequence to be determined. Such determined relationships facilitate language processing tasks.

The decoder 312B may be trained to predict a next word in a text sequence based on the prior words. This is optionally performed in part by shifting the output sequence to the right so that the decoder is only using the earlier words.

The output is converted to a numerical format, which may be referred to as output embeddings 308B. Positional encoding is optionally performed to facilitate the transformer model understanding of the order of words in a segment (e.g., a sentence). The set of numbers may be input 310B. A loss function, configured to calculate the difference between the transformer model's predictions and the actual values, may be utilized to adjust the transformer model to improve accuracy by reducing the difference between predictions and targets, and hence the error. During training, the output embeddings may compute the loss function and update the transformer model parameters to improve the transformer model performance. During an inference process, the output embeddings may generate output text by mapping the model's predicted probabilities of a given token to the corresponding token in the vocabulary.

The decoder 312B may receive the positionally encoded input representation and the positionally encoded output embeddings and, based on the foregoing, generates an output sequence. There may be one or more layers of decoders 312B. During the training process, the decoder learns how to predict the next word by examining the prior words. The decoder 312B may generate natural language text based on the input sequence and the context learned by the encoder.

A linear layer 314B may map the output embeddings from the decoder 312B to a higher-dimensional space to thereby transform the output embeddings from the decoder 312B into the original input space. A probability distribution function, 316B, such as the softmax function, may be applied to the output of the model's final layer, producing a vector of scores representing the likelihood of each possible output token in the vocabulary given the input sequence. The function may map these scores to a probability distribution over the vocabulary, with higher scores corresponding to higher probabilities.

By converting the output of the model into a probability distribution, the probability distribution function enables the transformer model to produce a prediction for the next token that is both informed by the input sequence and consistent with the language's syntax and semantics. This allows the model to generate fluent, coherent text that reflects the structure and style of the input text.

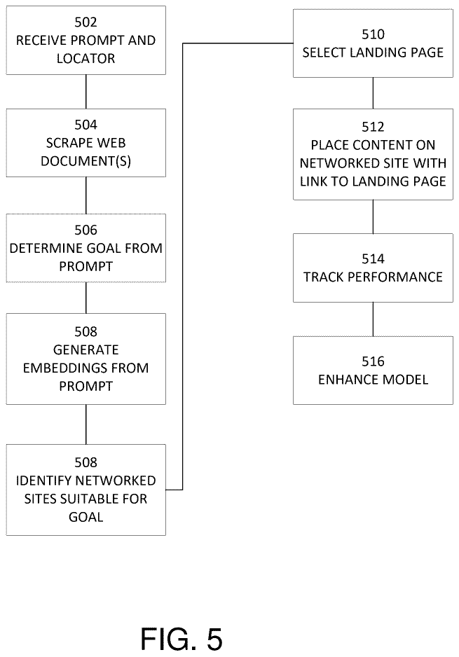

FIG. 5 illustrates an example process of networked content distribution and model enhancement. At block 502, a prompt is received from an entity. For example, the prompt may be received from an electronic form, such as that illustrated in FIG. 4. Optionally, other data, such as a locator (e.g., a URL) to a home page or product/service page, a name of the entity, and/or a name of the campaign may be received via the electronic form.

At block 504, web content at the webpage/website corresponding to the locator is scraped. Optionally, the entire website or a subset thereof associated with the locator may be scraped. Optionally, a product profile and/or entity profile may be generated from the scraped content. The entity profile may be utilized in addition to the prompt to determine what entity content is to be generated, where entity content is to be placed, and/or how much to pay/bid for entity content placement. For example, the scraped content may include detailed information on entity products (e.g., including detailed information on a product to be promoted via the entity content), brand style guidelines, product reviews, and/or other data.

For example, a web crawler program may be utilized to retrieve webpages from the entity's website as input information for generating the entity and/or product profiles. Optionally, the web crawler program (or other application) may be utilized to conduct a search of other networked websites or databases to retrieve documents and/or other data regarding the entity and/or products offered by the company to generate the entity profile. Optionally, the collected data is input by a generative model (e.g., an LLM) which is configured (e.g., prompted) to generate a summary of the content of the accessed web pages and data.

At block 506, the prompt is analyzed to determine the goal of the entity. For example, as similarly described elsewhere herein, a generative model may be utilized to determine an entity's goal from their prompt by analyzing the linguistic structure, extracting key entities, and using contextual reasoning. One optional technique utilizes intent recognition, where the model classifies the prompt into predefined categories, such as content placement, content generation, viewer responses, or problem-solving. Semantic parsing may be utilized to break down the prompt into actionable components, identifying what the entity is asking for and in what context. Natural Language Processing (NLP) techniques, such as Named Entity Recognition (NER) and keyword extraction, may be utilized to identify relevant intent-based words and phrases (e.g., “want,” “have the viewer,” “engage,” etc.).

At block 508, suitable third-party networked websites for entity content may be identified. For example, if the goal is the sale or user trial of a product, suitable sites may comprise e-commerce platforms, product review sites, sites that discuss the product type (e.g., an online automobile magazine for automobile ads, a cooking website for a cooking product ad, a travel website for a hotel ad, etc.), and/or websites where users show high purchase intent, such as comparison shopping engines. If the goal is to increase brand awareness, suitable sites may comprise high-traffic news websites, entertainment platforms, or social media. If the goal is to have users install an application on their devices, suitable sites may comprise mobile-first platforms, gaming sites, and/or app marketplaces where users are more likely to download and engage with applications. By aligning entity content placements with the website content and/or viewership, the achievement of the entity goal is more likely.

Optionally, a learning engine may be used to identify specific webpages for entity content placement using data-driven insights, machine learning algorithms, and/or user behavior analysis.

As similarly discussed elsewhere herein, embeddings corresponding to the entity prompt may be compared to embeddings generated from webpages using cosine similarity (such as described elsewhere herein) or other techniques. If there is sufficient similarity between the embeddings, the webpage may be suitable for entity content placement.

Optionally, a hybrid approach may be utilized to identify appropriate network-accessible locations (e.g., webpages or other content) to place entity content. For example, a combination of supervised learning, reinforcement learning, natural language processing (NLP), and/or unsupervised learning may be utilized to optimize the likelihood that the placement of the entity content will result in achieving a goal of the entity.

For example, supervised learning models, such as logistic regression, random forests, and/or deep neural networks, may be utilized to predict which webpages will drive conversions or other entity goals based on historical ad performance data. Reinforcement learning (RL) techniques, such as multi-armed bandits or deep Q-networks, may be utilized to continuously adjust entity content placements by learning which websites yield the highest percentage of goal accomplishment. NLP models, such as transformer-based architectures described herein, may be utilized to analyze webpage content to ensure contextual relevance between the entity content and the page's topic. Optionally, unsupervised learning, using clustering algorithms such as K-means, may be utilized to segment audiences based on user behavior and to identify user groups that are actively interested in purchasing or trying product-types being offered by the entity.

At block 510, a landing page of the entity may be selected, which may be the webpage corresponding to the locator provided at block 502. For example, if the entity content being placed on third party sites is related to a particular car model and the goal is to have a viewer test drive the car model, a link to a webpage on the entity's website that enables a test drive to be scheduled may be selected, and a corresponding link may be associated with (e.g., embedded in) the entity content being placed. Then, when a viewer clicks on the entity content, the viewer's browser hosted on a viewer device will be navigated to the test drive reservation webpage.

At block 512, the entity content is placed on the selected network site, optionally via a bidding or other placement process, such as those described herein and in Appendices A and B, the content of which is incorporated herein in their entirety.

For example, when a user visits a webpage, the process of routing and displaying entity content, such as an ad, is optionally performed almost instantly through real-time bidding (RTB), programmatic advertising, and/or ad-serving technologies. The webpage makes a request to an ad server or an ad exchange (such as system 104), transmitting user data such as location, browsing behavior, and/or device type. The ad exchange then conducts an auction among promotors of products and services (such as the entity described herein), optionally using demand-side platforms (DSPs) that placement control value in real time for the ad space based on relevance (e.g., determined as described herein) and the promoter's budget. The highest ranked placement control value wins the auction (where the ranking may be determined using the placement control value, the ad relevance to the webpage content, other factors described herein, and/or other criteria), and the corresponding ad is selected for display. The ad server then delivers the chosen ad (e.g., a banner, video, graphic, still image, and/or native ad) by injecting the appropriate HTML, JavaScript, or media elements into the webpage.

Optionally, the entity system may utilize an automated agent configured to implement a specified bidding strategy by executing bidding computer code and/or processing text through language models to automatically generate a placement control value on behalf of an entity.

At block 514, the performance of the content placement may be tracked. For example, the ratio of goal achievement versus entity content impression may be tracked. Optionally, a dashboard may be generated that accesses and displays tracked performance per website, over time, at different times of day, in different regions, and/or the like. The dashboard may be an interactive dashboard and may be rendered on a user device.

For example, a performance-tracking dashboard for entity content placements may be configured to provide a real-time and/or historical view of how entity content placement performs across different websites, time periods, and geographic regions. The dashboard optionally includes interactive visualizations, such as line charts to track click-through rates (CTR) and conversions over time, heatmaps to display regional engagement, and/or bar graphs comparing entity content placement performance across multiple websites. Optionally, the dashboard may provide filter controls to filter the displayed data. For example, filters may be provided and applied so that only data for specified regions and/or times of day are to be displayed. This enables trends to be analyzed by time of day, identifying peak engagement hours, or by region, assessing which locations result in the highest rate or most goal achievements. Optionally, the dashboard may provide key performance indicators (KPIs) such as CTR, conversion rate, return on ad spend (ROAS), and cost per acquisition (CPA), enabling entities to optimize content campaigns efficiently. Additionally, a learning engine may be utilized to identify underperforming placements and/or to generate recommended changes in content placement.

At block 516, the tracked performance may be utilized to enhance the generative and/or predictive models. Patterns of errors may be identified, model parameters may be adjusted, and the model may be further trained or retrained with new data. Thus, the model(s) may be trained so as to learn from its past mistakes, to enhance the model's prediction accuracy, and to adapt to new scenarios.

Thus, methods and systems are described herein configured to enable a prompt comprising one or more goals to be utilized to automatically generate a content distribution campaign, including the selection of networked sites for the placement of content, the selection of content to be placed, and the selection of a landing page associated with the placed content. The achievement of goals may be monitored, and artificial intelligence models used in generating the content distribution campaign may be improved so as to increase the likelihood of success in the achievement of goals.

An aspect of the present disclosure relates to a computer system, the computer system comprising: a network interface; and at least one processing device configured to: provide for a display on a device of a first entity a user interface comprising a prompt field; receive via the network interface a prompt provided via the prompt field; use a model to determine, from the prompt, a goal; based at least on the goal, identify at least a first networked site suitable for a first item of content; and cause the first item of content to be transmitted over a network to and rendered on a display of a user device via the first networked site.

Optionally, communication between the computer system and the user device is encrypted using Transport Layer Security over HTTPS, and wherein the computer system uses public key infrastructure with asymmetric encryption to exchange cryptographic keys, homomorphic encryption to process placement control value data while encrypted, hashing algorithms to anonymize user identifiers, and/or elliptic curve cryptography to reduce processing overhead.

Optionally, the model is configured to generate vector embeddings for the prompt and for content of candidate networked sites using a trained neural network, and to compute similarity scores between the vector embeddings to reduce network bandwidth and processor utilization by eliminating networked sites below a similarity threshold.

Optionally, the at least one processing device is further configured to scrape and index content from a website corresponding to the locator, and to use the scraped and indexed content in conjunction with the prompt to select and/or generate the first item of content and to determine at least one webpage on which the first item of content is to be placed.

Optionally, the model comprises an agentic artificial intelligence model configured as an autonomous agent capable of determining goals from prompts, generating content, determining where to place content.

Optionally, the prompt is a free form, natural language prompt comprising the goal and a description of one or more characteristics of a product.

Optionally, the system is configured to: identify at least the first networked site suitable for the first item of content based in part on data scraped from a website associated with the first entity.

Optionally, the system is configured to: determine a match value between the prompt and the first networked site; and based at least on the match value, determine a token amount to offer for placement of the first item of content on the first networked site.

Optionally, the system is configured to generate the first item of content using a generative model based at least in part on the goal.

Optionally, the system is configured to: determine how often the goal was achieved; and based at least in part on how often the goal was achieved, determine whether to enhance the model.

Optionally, the system is configured to determine, from the prompt, the goal by analyzing a linguistic structure of the prompt, extracting key entities of the prompt, and using contextual reasoning.

Optionally, the system is configured to generate a real time dashboard configured to display tracked performance of placement of the first item of content on a plurality of websites.

An aspect of the present disclosure relates to a computer-implemented method, the method comprising: providing for a display on a device of a first entity a user interface comprising a prompt field; receiving, at a computer system via a network interface, an encrypted prompt provided via the prompt field; decrypting the encrypted prompt; using a computer-executed model to infer from the prompt a desired state; based at least on the desired state, identifying at least a first networked site suitable for a first item of content; and causing the first item of content to be transmitted over a network to and rendered on a display of a user device via the first networked site.

Optionally, receiving the encrypted prompt comprises receiving the encrypted prompt over Transport Layer Security (TLS) over HTTPS, and wherein the method further comprises using public key infrastructure with asymmetric encryption to exchange cryptographic keys, using homomorphic encryption to process placement control value data while encrypted, using hashing algorithms to anonymize user identifiers, and/or using elliptic curve cryptography to reduce processing overhead.

Optionally, identifying at least the first networked site comprises generating vector embeddings for the prompt and for content of candidate networked sites using a trained neural network, computing similarity scores between the vector embeddings, and eliminating candidate networked sites having similarity scores below a similarity threshold to reduce network bandwidth and processor utilization.

Optionally, the method further comprises: identifying at least the first networked site suitable for the first item of content based in part on data scraped from a website associated with the first entity.

Optionally, the method further comprises: determining a match value between the prompt and the first networked site; and based at least on the match value, determining a token amount to offer for placement of the first item of content on the first networked site.

Optionally, the method further comprises generating the first item of content using a generative model based at least in part on the desired state.

Optionally, the method further comprises: determining how often the desired state was achieved; and based at least in part on how often the desired state was achieved, determining whether to enhance the model.

Optionally, the method further comprises determining, from the prompt, the desired state by analyzing a linguistic structure of the prompt, extracting key entities of the prompt, and using contextual reasoning.

Optionally, the method further comprises generating a real time dashboard configured to display tracked performance of placement of the first item of content on a plurality of websites.

An aspect of the present disclosure is related to a non-transitory computer readable memory having program instructions stored thereon that when executed by a computer system comprising a computing device cause the computer system to perform operations comprising: provide for a display on a device of a first entity a user interface; receive an encrypted prompt provided via the user interface; enabling the encrypted prompt to be decrypted; using a computer-executed model to identify at least a first networked site suitable for a first item of content; and cause the first item of content to be transmitted over a network to and rendered on a display of a user device via the first networked site.

Optionally, the operations further comprise: identifying at least the first networked site suitable for the first item of content based in part on data scraped from a website associated with the first entity.

Optionally, the operations further comprise: determining a match value between the prompt and the first networked site; and based at least on the match value, determining a token amount to offer for placement of the first item of content on the first networked site.

Optionally, the operations further comprise generating the first item of content using a generative model based at least in part on the desired state.

Optionally, the operations further comprise: determining how often the desired state was achieved; and based at least in part on how often the desired state was achieved, determining whether to enhance the model.

Optionally, the operations further comprise determining, from a prompt, a desired state by analyzing a linguistic structure of the prompt, extracting key entities of the prompt, and using contextual reasoning.

Optionally, the operations further comprise generating a real time dashboard configured to display tracked performance of placement of the first item of content on a plurality of websites.

An aspect of the present disclosure relates to a non-transitory computer-readable medium having program instructions stored thereon that, when executed by one or more processing devices of a computer system comprising a network interface, cause the computer system to perform operations comprising: providing, for display on a device of an entity, a user interface comprising a prompt field; receiving, via the network interface, a prompt provided via the prompt field, the prompt comprising free-form natural language text describing a desired state; generating, using a trained neural network, a vector embedding representing semantic content of the prompt; generating, using the trained neural network, vector embeddings representing content of candidate networked sites, wherein the prompt embedding and the site embeddings exist in a shared vector space; computing similarity scores between the prompt embedding and the site embeddings and eliminating candidate networked sites having similarity scores below a relevance threshold to reduce network bandwidth and processor utilization; identifying, based on the similarity scores, at least a first networked site suitable for routing digital content; and causing a first item of content to be transmitted over a network to and rendered on a display of a user device via the first networked site, wherein communication between the computer system and the user device is encrypted using Transport Layer Security over HTTPS, and wherein the computer system uses one or more of public key infrastructure with asymmetric encryption, homomorphic encryption, hashing algorithms to anonymize user identifiers, or elliptic curve cryptography to reduce processing overhead.

Optionally, the user interface comprises an entity name field configured to receive a name of the entity, a locator field configured to receive a a locator to an electronic destination, and the prompt field configured to receive the free-form natural language prompt.

Optionally, computing the similarity scores comprises computing cosine similarity between the prompt embedding and each site embedding, and ranking the candidate networked sites based at least in part on respective cosine similarity scores.

Optionally, the one or more processing devices comprise a plurality of processing cores configured to execute convolution instructions to enhance performance of execution of the trained neural network.

Systems and modules described herein may comprise software, firmware, hardware, or any combination(s) of software, firmware, or hardware suitable for the purposes described. Software and other modules may reside and execute on servers, workstations, personal computers, computerized tablets, PDAs, and other computing devices suitable for the purposes described herein. Software and other modules may be accessible via local computer memory, via a network, via a browser, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, interactive voice response, command line interfaces, and other suitable interfaces.

Further, processing of the various components of the illustrated systems can be distributed across multiple machines, networks, and other computing resources, or may comprise a standalone system. Two or more components of a system can be combined into fewer components. Various components of the illustrated systems can be implemented in one or more virtual machines, rather than in dedicated computer hardware systems and/or computing devices. Likewise, the data repositories shown can represent physical and/or logical data storage, including, e.g., storage area networks or other distributed storage systems. Moreover, in some embodiments the connections between the components shown represent possible paths of data flow, rather than actual connections between hardware. While some examples of possible connections are shown, any of the subsets shown can communicate with any other subset of components in various implementations.

Embodiments are also described above with reference to flow chart illustrations and/or block diagrams of methods, apparatus (systems) and computer program products. Each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, specially-equipped computer (e.g., comprising a high-performance database server, a graphics subsystem, etc.) or other programmable data processing apparatus to produce a machine, such that the instructions, which execute via the processor(s) of the computer or other programmable data processing apparatus, create means for implementing the acts specified in the flow chart and/or block diagram block or blocks. These computer program instructions may also be stored in a non-transitory computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded to a computing device or other programmable data processing apparatus to cause operations to be performed on the computing device or other programmable apparatus to produce a computer implemented process such that the instructions which execute on the computing device or other programmable apparatus provide steps for implementing the acts specified in the flow chart and/or block diagram block or blocks.

While the phrase “click” may be used with respect to a user selecting a control, menu selection, or the like, other user inputs may be used, such as voice commands, text entry, gestures, etc. User inputs may, by way of example, be provided via an interface, such as via text fields, wherein a user enters text, and/or via a menu selection (e.g., a drop down menu, a list or other arrangement via which the user can check via a check box or otherwise make a selection or selections, a group of individually selectable icons, etc.). When the user provides an input or activates a control, a corresponding computing system may perform the corresponding operation. Some or all of the data, inputs and instructions provided by a user may optionally be stored in a system data store (e.g., a database), from which the system may access and retrieve such data, inputs, and instructions. The notifications and user interfaces described herein may be provided via a Web page, a dedicated or non-dedicated phone or mobile application, computer application, a short messaging service message (e.g., SMS, MMS, etc.), instant messaging, email, push notification, audibly, via haptic feedback, and/or otherwise.

The user terminals described herein may be in the form of a mobile communication device (e.g., a cell phone), laptop, tablet computer, interactive television, game console, media streaming device, head-wearable display, networked watch, etc. The user terminals may optionally include displays, user input devices (e.g., touchscreen, keyboard, mouse, microphone, camera, touch pad, etc.), network interfaces, etc.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention. These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates other aspects of the invention in any number of claim forms. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application, in either this application or in a continuing application.

1. A computer system, the computer system comprising:
a network interface; and
at least one processing device configured to:
provide for a display on a device of a first entity a user interface comprising a prompt field;
receive via the network interface a prompt provided via the prompt field;
use a model to determine, from the prompt, a goal;
based at least on the goal, identify a networked site by computing for a candidate networked site, a similarity score between a prompt embedding and a site profile embedding that represents:
content of the candidate networked site, and
viewership attributes associated with the candidate networked site;
eliminating, based at least in part on the similarity score, candidate networked sites having similarity scores that fail to satisfy a relevance threshold, and identifying a first networked site having a similarity score that satisfies the relevance threshold; and
cause a first item of content to be transmitted over a network to and rendered on a display of a user device via the first networked site, wherein communication between the computer system and the user device is encrypted using Transport Layer Security over HTTPS, and wherein the computer system uses public key infrastructure with asymmetric encryption to exchange cryptographic keys, homomorphic encryption to process value data while encrypted, hashing algorithms to anonymize user identifiers, and/or elliptic curve cryptography to reduce processing overhead.

2. The computer system of claim 1, wherein the model is configured to generate vector embeddings for the prompt and for content of candidate networked sites using a trained neural network, and to compute similarity scores between the vector embeddings to reduce network bandwidth and processor utilization by eliminating networked sites below a similarity threshold.

3. The computer system of claim 1, wherein the at least one processing device is further configured to scrape and index content from a website corresponding to a locator, and to use the scraped and indexed content in conjunction with the prompt to select and/or generate the first item of content and to determine at least one webpage on which the first item of content is to be placed.

4. The computer system of claim 1, wherein the model comprises an agentic artificial intelligence model configured as an autonomous agent capable of determining goals from prompts, generating content, determining where to place content.

5. The computer system as defined in claim 1, wherein the prompt is a free form, natural language prompt comprising the goal and a description of one or more characteristics of a product.

6. The computer system as defined in claim 1, wherein the system is configured to:
identify at least the first networked site suitable for the first item of content based in part on data scraped from a website associated with the first entity.

7. The computer system as defined in claim 1, wherein the system is configured to:
determine a match value between the prompt and the first networked site; and
based at least on the match value, determine a token amount to offer for placement of the first item of content on the first networked site.

8. The computer system as defined in claim 1, wherein the system is configured to generate the first item of content using a generative model based at least in part on the goal.

9. The computer system as defined in claim 1, wherein the system is configured to:
determine how often the goal was achieved; and
based at least in part on how often the goal was achieved, determine whether to enhance the model.

10. The computer system as defined in claim 1, wherein the system is configured to determine, from the prompt, the goal by analyzing a linguistic structure of the prompt, extracting key entities of the prompt, and using contextual reasoning.

11. The computer system as defined in claim 1, wherein the system is configured to generate a real time dashboard configured to display tracked performance of placement of the first item of content on a plurality of websites.

12. A computer-implemented method, the method comprising:
providing for a display on a device of a first entity a user interface comprising a prompt field;
receiving, at a computer system via a network interface, an encrypted prompt provided via the prompt field;
decrypting the encrypted prompt;
using a computer-executed model to infer from the prompt a desired state;
based at least on the desired state, identifying at least a first networked site suitable for a first item of content by computing, for candidate networked sites, respective similarity scores between an embedding of the prompt and site-associated embeddings corresponding to the candidate networked sites, wherein the site-associated embeddings are generated based at least in part on content of the candidate networked sites, and wherein the identifying is further based at least in part on viewership attributes associated with the candidate networked sites, eliminating candidate networked sites having respective similarity scores that fail to satisfy a similarity threshold, and identifying the first networked site from the candidate networked sites having a respective similarity score that satisfies the similarity threshold; and
causing the first item of content to be transmitted over a network to and rendered on a display of a user device via the first networked site.

13. The computer-implemented method of claim 12, wherein receiving the encrypted prompt comprises receiving the encrypted prompt over Transport Layer Security (TLS) over HTTPS, and wherein the method further comprises using public key infrastructure with asymmetric encryption to exchange cryptographic keys, using homomorphic encryption to process value data while encrypted, using hashing algorithms to anonymize user identifiers, and/or using elliptic curve cryptography to reduce processing overhead.

14. The computer-implemented method of claim 12, wherein identifying at least the first networked site comprises generating vector embeddings for the prompt and for content of candidate networked sites using a trained neural network, computing similarity scores between the vector embeddings, and eliminating candidate networked sites having similarity scores below a similarity threshold to reduce network bandwidth and processor utilization.

15. The computer-implemented method as defined in claim 12, the method further comprising:
identifying at least the first networked site suitable for the first item of content based in part on data scraped from a website associated with the first entity.

16. The computer-implemented method as defined in claim 12, the method further comprising:
determining a match value between the prompt and the first networked site; and
based at least on the match value, determining a token amount to offer for placement of the first item of content on the first networked site.

17. The computer-implemented method as defined in claim 12, the method further comprising generating the first item of content using a generative model based at least in part on the desired state.

18. The computer-implemented method as defined in claim 12, the method further comprising:
determining how often the desired state was achieved; and
based at least in part on how often the desired state was achieved, determining whether to enhance the model.

19. The computer-implemented method as defined in claim 12, the method further comprising determining, from the prompt, the desired state by analyzing a linguistic structure of the prompt, extracting key entities of the prompt, and using contextual reasoning.

20. The computer-implemented method as defined in claim 12, the method further comprising generating a real time dashboard configured to display tracked performance of placement of the first item of content on a plurality of websites.

21. A non-transitory computer-readable medium having program instructions stored thereon that, when executed by one or more processing devices of a computer system comprising a network interface, cause the computer system to perform operations comprising:
providing, for display on a device of an entity, a user interface comprising a prompt field;
receiving, via the network interface, a prompt provided via the prompt field, the prompt comprising free-form natural language text describing a desired state;
generating, using a trained neural network, a vector embedding representing semantic content of the prompt;
generating, using the trained neural network, vector embeddings representing content of candidate networked sites, wherein the prompt embedding and the site embeddings exist in a shared vector space;
computing, for candidate networked sites, respective similarity scores between the prompt embedding and site-associated embeddings corresponding to the candidate networked sites, wherein the site-associated embeddings are generated based at least in part on content of the candidate networked sites;
identifying at least a first networked site suitable for routing digital content from the candidate networked sites based at least in part on the respective similarity scores and viewership attributes associated with the candidate networked sites, including by eliminating candidate networked sites having respective similarity scores that fail to satisfy a relevance threshold, and identifying the first networked site from the candidate networked sites having a respective similarity score that satisfies the relevance threshold;
identifying at least the first networked site from the candidate networked sites having a respective similarity score that satisfies the relevance threshold as suitable for routing digital content; and
causing a first item of content to be transmitted over a network to and rendered on a display of a user device via the first networked site,
wherein communication between the computer system and the user device is encrypted using Transport Layer Security over HTTPS, and wherein the computer system uses one or more of public key infrastructure with asymmetric encryption, homomorphic encryption, hashing algorithms to anonymize user identifiers, or elliptic curve cryptography to reduce processing overhead.

22. The non-transitory computer-readable medium of claim 21, wherein the user interface comprises an entity name field configured to receive a name of the entity, a locator field configured to receive a locator to an electronic destination, and the prompt field configured to receive the free-form natural language prompt.

23. The non-transitory computer-readable medium of claim 21, wherein computing the similarity scores comprises computing cosine similarity between the prompt embedding and each site embedding, and ranking the candidate networked sites based at least in part on respective cosine similarity scores.

24. The non-transitory computer-readable medium of claim 21, wherein the one or more processing devices comprise a plurality of processing cores configured to execute convolution instructions to enhance performance of execution of the trained neural network.
